(19) United States
(12) Patent Application Publication
(10) Pub. No.: US 2009/0140963 A1
(43) Pub. Date: Jun. 4, 2009

(54) IMAGE DISPLAY DEVICE

(75) Inventors: Tsuyoshi OKUMURA, Osaka (JP); Masaya NAKAMICHI, Kyoto (JP); Nobuyuki TAKE, Osaka (JP); Eisuke KAMIESU, Osaka (JP); Ryusuke HIROTA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/251,494

(22) Filed: Oct. 15, 2008

(30) Foreign Application Priority Data
Dec. 3, 2007 (JP) 2007-312605

(51) Int. Cl. G09G 3/36

(52) U.S. Cl. 345/87

(57) ABSTRACT

An image display device of the present invention comprises a casing including a front cabinet and a back cabinet, a liquid crystal display panel, a main circuit board for causing an image to be displayed on the liquid crystal display panel and a power supply unit board. A recess is defined on a rear surface of the back cabinet and the main circuit board and the power supply unit board are placed in the recess.

The priority application Number 2007-312605 upon which this patent application is based is hereby incorporated by reference.

### BACKGROUND OF THE INVENTION

1. Field of the Invention

The present invention relates to an image display device for a television receiver and a monitor device, and particularly to an image display device provided with a flat display panel such as a liquid crystal display panel and a plasma display panel.

2. Description of Related Art

A flat image display device of this type includes a flat display panel housed in a thin casing. A circuit board for driving the flat display panel is arranged on a rear surface of the flat display panel (see Japanese Patent Laid-Open No. 2004-317919).

As an example, in a television receiver with a liquid crystal display (LCD), as shown in FIG. 11, a liquid crystal display panel 4 and a circuit board 6 are arranged between a front cabinet 1 and a back cabinet 20. The circuit board 6 is provided with a television broadcast receiver circuit or the like mounted thereon for causing an image to be displayed on the liquid crystal display panel 4. As shown in FIG. 10, the liquid crystal display panel 4 is attached to the front cabinet 1 by using two metal arms 91, 91. The circuit board 6 is fixedly attached by using a plurality of screws 8 to a rear surface of a metal frame 9 fixed to the two metal arms 91, 91.

The conventionally employed television receiver shown in FIGS. 10 and 11 uses the metal frame 9 and the two metal arms 91, 91, resulting in the increase in weight and in number of parts. Further, the removal work of burrs generated in the process of forming the metal frame 9 results in cost increase.

To solve these problems, the circuit board 6 can be attached to an inner surface of the back cabinet 20, thereby omitting the metal frame 9 and the metal arms 91, 91. In such a case, however, in the assembly process, it will be required to connect the liquid crystal display panel 4 and the circuit board 6 to each other using lead wires with the liquid crystal display panel 4 fixed on an inner surface of the front cabinet 1 and the circuit board 6 fixed on the inner surface of the back cabinet 20. That then requires connection operation of lead wires with the front cabinet 1 and the back cabinet 20 facing each other and being approximate to each other, which is difficult because of extremely narrow work space.

### SUMMARY OF THE INVENTION

An object of the present invention is to provide an image display device which is lighter in weight than a conventional device without difficulty in the assembly work.

An image display device according to the present invention comprises: a casing including a front cabinet and a back cabinet; a flat display panel arranged inside the casing; and one or more circuit boards provided with electronic components mounted thereon that cause an image to be displayed on the flat display panel. A recess is provided on a rear surface of the back cabinet, and the circuit boards other than the circuit boards attached directly to the flat display panel are placed in this recess. The back cabinet is made of synthetic resin and the recess is formed by resin molding.

A particular configuration is such that a cover for covering said recess is provided on the rear surface of the back cabinet. Further, an opening is defined to penetrate a bottom wall of said recess of the back cabinet, and at least one of the circuit boards in said recess is connected to the flat display panel through this opening.

In the image display device according to the present invention, one or more circuit boards provided with electronic components mounted thereon that cause an image to be displayed on the flat display panel are placed in the recess on the rear surface of the back cabinet, except the circuit board attached directly to the rear surface of the flat display panel. Therefore, in the assembly process, the connection operation of the circuit board and the flat display panel can be conducted with the flat display panel fixed on the inner surface of the front cabinet, the front cabinet and the back cabinet fitted together, and the circuit board placed in the recess opening on the rear surface of the back cabinet.

As described above, in the image display device of the present invention, since the circuit boards other than the circuit boards attached directly to the rear surface of the flat display panel can be attached to the back cabinet, the metal frame and the metal arms for attaching these circuit boards to the front cabinet can be omitted, thereby realizing lighter weight than the conventional device. Moreover, the connection operation of the circuit board and the flat display panel can be conducted on the side of the rear surface of the back cabinet with the front cabinet and the back cabinet fitted together, and therefore, the work space can be sufficient, resulting in good workability.

### BRIEF DESCRIPTION OF THE DRAWINGS

FIG. 1 is a perspective view of a liquid crystal display television receiver of the present invention viewed from the front side thereof;

FIG. 2 is a perspective view of the liquid crystal display television receiver viewed from the side of the rear surface thereof;

FIG. 3 is an exploded perspective view of the liquid crystal display television receiver;

FIG. 4 is an exploded perspective view of a liquid crystal display panel and a back cabinet;

FIG. 5 is a perspective view of the back cabinet viewed from the side of the rear surface thereof;

FIG. 6 is an exploded perspective view of the back cabinet, a main circuit board and a power supply unit board;

FIG. 7 is a perspective view of the back cabinet provided with the main circuit board and the power supply unit board thereon;

FIG. 8 is a perspective view of a back cabinet in a different embodiment;

FIG. 9 is a block diagram illustrating the configuration of the liquid crystal display television receiver of the present invention;

FIG. 10 is a perspective view of a front cabinet provided with a liquid crystal display panel and a circuit board thereon in a conventional liquid crystal display television receiver; and

FIG. 11 is an exploded perspective view of the conventional liquid crystal display television receiver.

### DETAILED DESCRIPTION OF THE EMBODIMENTS

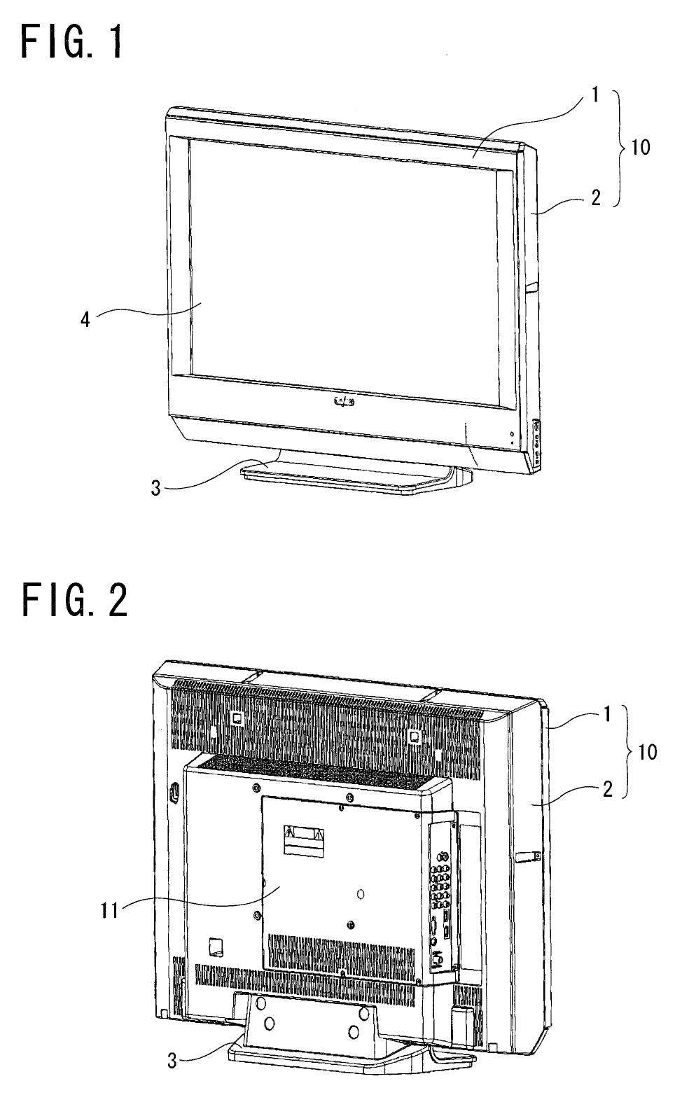

In a preferred embodiment discussed in detail below with reference to the drawings, the present invention is implemented in a liquid crystal display television receiver. As shown in FIGS. 1 and 2, the liquid crystal display television receiver according to the present invention comprises a thin casing 10 including a front cabinet 1 and a back cabinet 2, and the casing 10 is capable of self-standing by means of a stand 3. A cover 11 is provided on the rear surface of the back cabinet 2 for covering a recess for receiving a circuit board to be described later. The front cabinet 1, the back cabinet 2, and the cover 11 are resin molded articles made of synthetic resin.

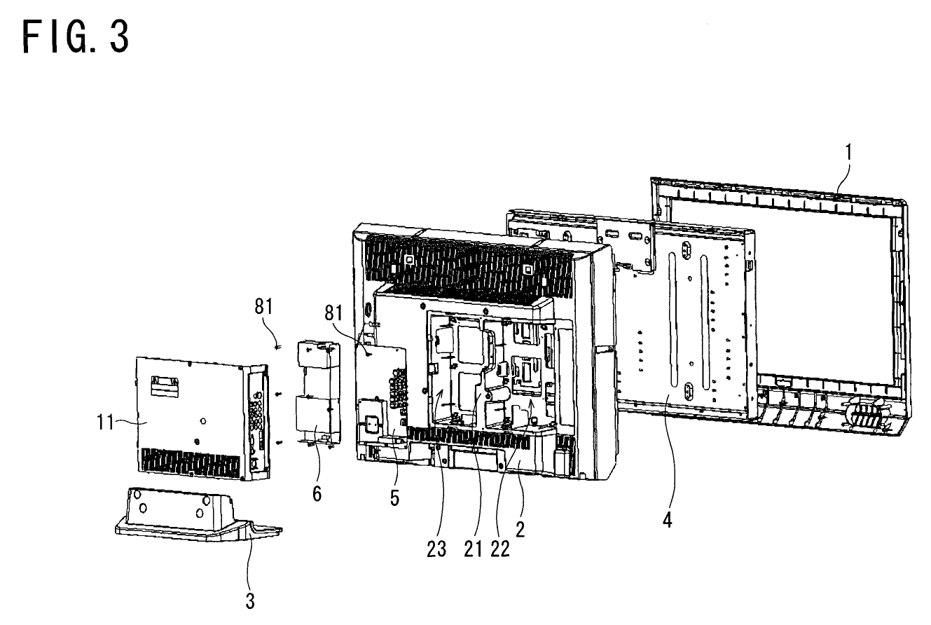

As shown in FIG. 3, the front cabinet 1 is provided with a liquid crystal display panel 4 disposed on the rear surface thereof, and the back cabinet 2 is provided covering the liquid crystal display panel 4. The liquid crystal display panel 4 used here includes the liquid crystal display panel body and a backlight unitized with each other. Further, a driver circuit board (not shown) and an inverter circuit board (not shown) are attached directly to the side of a rear surface of this unit. The driver circuit board is provided with a driver circuit mounted thereon for causing an image to be displayed on the screen of the liquid crystal display panel, and the inverter circuit board controls the backlight.

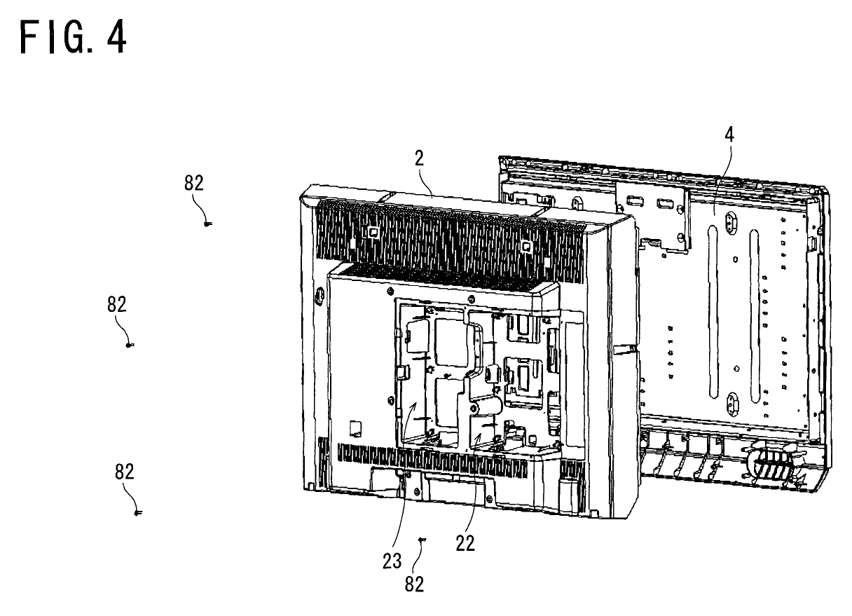

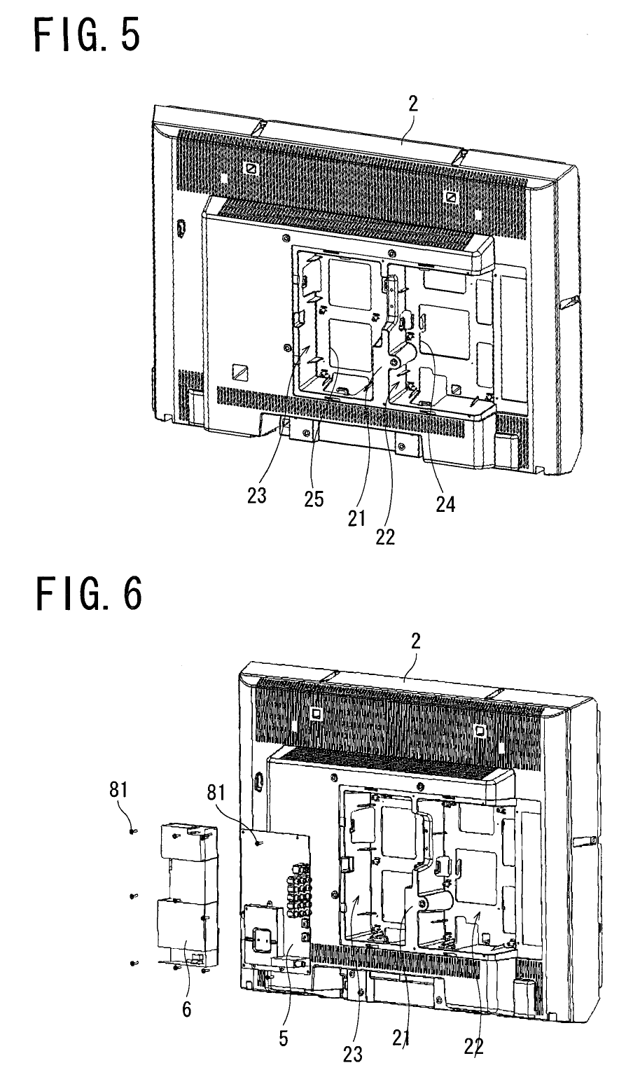

A first recess 22 and a second recess 23 are defined on the rear surface of the back cabinet 2, and the first recess 22 and the second recess 23 are divided by a bar 21. A main circuit board 5 is placed in the first recess 22, and a power supply unit board 6 is placed in the second recess 23. As shown in FIG. 4, the back cabinet 2 is fastened to the liquid crystal display panel 4 by using a plurality of screws 82, as well as to the front cabinet 1. As shown in FIG. 5, an opening 24 penetrating a bottom wall of the first recess 22 and an opening 25 penetrating a bottom wall of the second recess 23 are defined on the back cabinet 2.

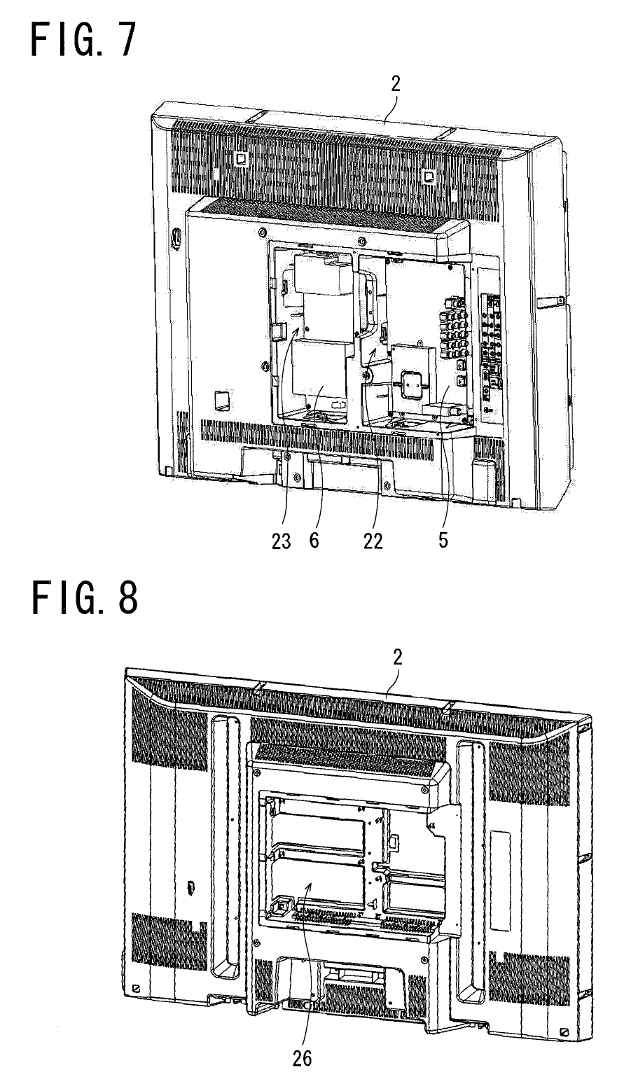

As shown in FIGS. 6 and 7, the main circuit board 5 is placed in the first recess 22 while the power supply unit board 6 is placed in the second recess 23 of the back cabinet 2, and these boards 5, 6 are fastened to the back cabinet 2 by using a plurality of screws 81.

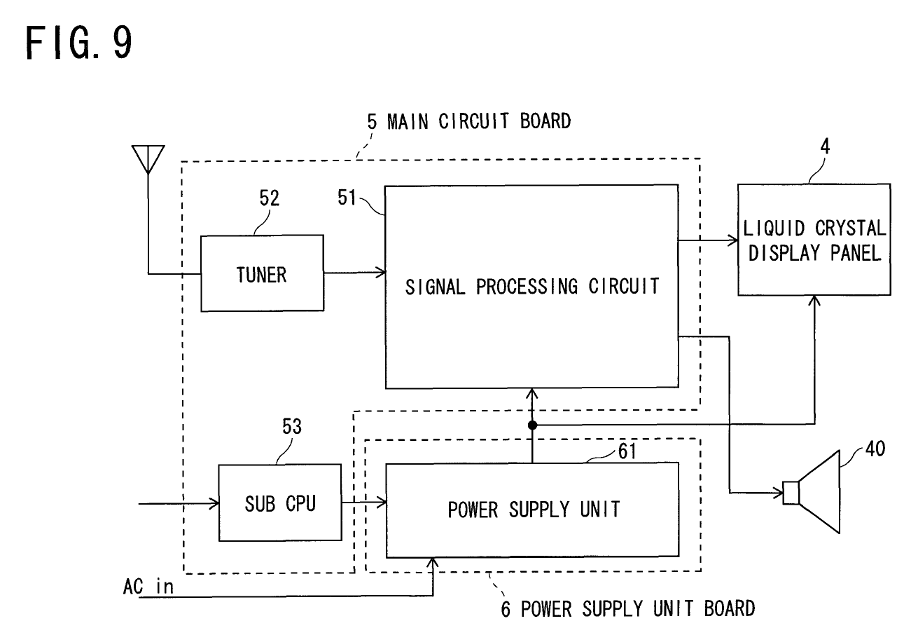

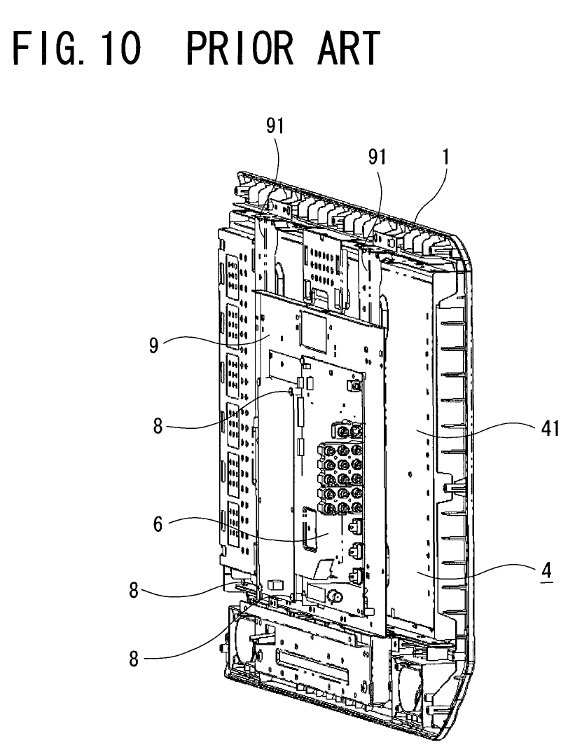

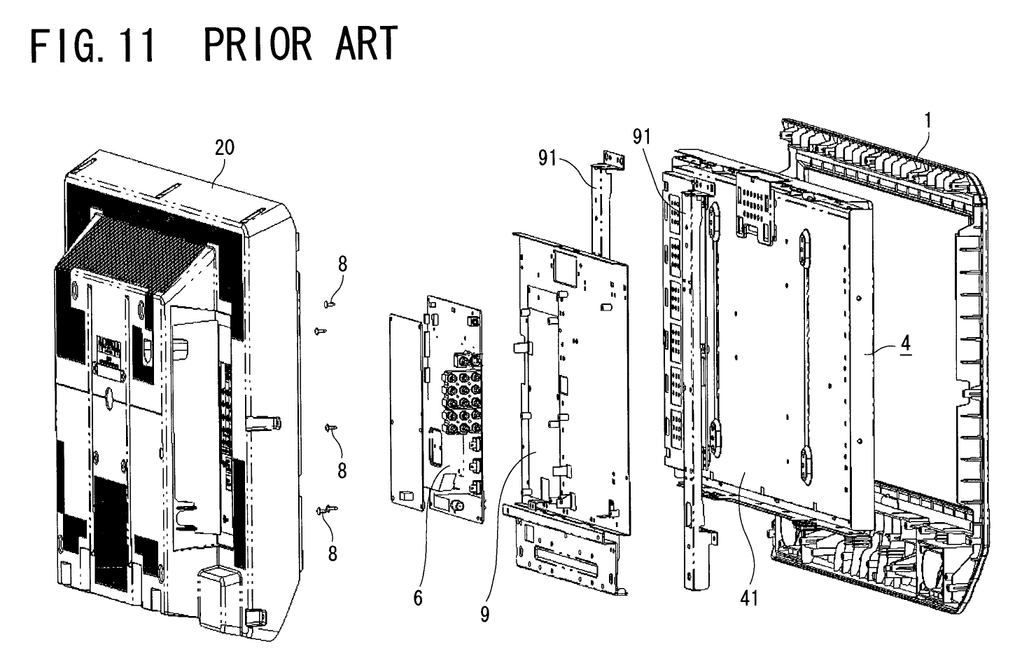

FIG. 9 illustrates the circuit configuration of the above discussed liquid crystal display television receiver. The main circuit board 5 has a signal processing circuit 51 which supplies image signals to the liquid crystal display panel 4 as well as audio signals to a speaker 40, a tuner 52 which receives television broadcast, and a sub CPU 53 which processes operation signals and the like from the operation keys (not shown), that are mounted on the main circuit board 5. The power supply unit board 6 has a power supply unit 61 mounted thereon, which supplies power to the signal processing circuit 51, the liquid display panel 4, and the like.

FIG. 9 shows only the power supply routes from the power supply unit 61 to the signal processing circuit 51 and the liquid crystal display panel 4, and other power supply routes are omitted. A control board (not shown) supplies signals to the sub CPU 53 shown in FIG. 9 upon instruction such as remote control signal from the user. The control board is placed inside the casing 10.

In the assembly process of the above discussed liquid crystal display television receiver, after the liquid crystal display panel 4 is fixed to the front cabinet 1 shown in FIG. 3, the main circuit board 5 is placed in the first recess 22 of the back cabinet 2 while the power supply unit board 6 is placed in the second recess 23 with the back cabinet 2 covering the front cabinet 1.

Then, a plurality of lead wires (not shown) extending from the liquid crystal display panel 4 are pulled out to the side of the rear surface of the back cabinet 2 through the openings 24, 25 of the back cabinet 2 shown in FIG. 5, and male connectors (not shown) attached at tip portions of the lead wires are connected to female connectors (not shown) on the main circuit board 5 and the power supply unit board 6. And then, the main circuit board 5 and the power supply unit board 6 are fastened to the back cabinet 2 by using the plurality of screws 81 shown in FIG. 6.

Subsequently, the back cabinet 2 is fastened to the liquid crystal display panel 4 and the front cabinet 1 by using the plurality of screws 82 shown in FIG. 4. And then the cover 11 is provided on the rear surface of the back cabinet 2 to cover said first recess 22 and second recess 23. Lastly, the stand 3 is attached to the front cabinet 1 and the back cabinet 2, which are fastened to each other, to complete the liquid crystal display television receiver according to the present invention shown in FIGS. 1 and 2.

As discussed above, in the liquid crystal display television receiver of the present invention, since the driver circuit board for driving the liquid crystal display panel 4 and the inverter circuit board for controlling the backlight are fixed directly to the rear surface of the liquid crystal display panel 4 as components of the liquid crystal display panel 4 while the main circuit board 5 and the power supply unit board 6 are attached to the back cabinet 2, the metal frame and the metal arms conventionally used for attaching the boards to the front cabinet can be omitted, thereby realizing lighter weight than the conventional device.

Moreover, the connection operation of the main circuit board 5 and the power supply unit board 6 to the liquid crystal display panel 4 can be conducted on the side of the rear surface of the back cabinet 2 with the front cabinet 1 and the back cabinet 2 fitted together, therefore, the work space can be sufficient, resulting in good workability.

Further, since the rigidity of the back cabinet 2 itself is increased by the existence of the first recess 22 and the second recess 23, the back cabinet 2 has a sufficient intensity required to fix the main circuit board 5 and the power supply unit board 6 thereto.

The structure of each part of the present invention is not limited to that shown in the preferred embodiment discussed above. Various modifications which an expert in the pertinent technical field can realize can be devised without departing from the scope of the spirit of the invention recited in claims. For example, in the embodiment shown in FIGS. 1 to 7, the bar 21 is defined on the back cabinet 2 to divide the first recess 22 and the second recess 23, however, it is also possible to define a single recess 26 on the rear surface of the back cabinet 2 and place one or more boards in this recess 26, as shown in FIG. 8.

Further, the present invention can be implemented not only in television receivers but also in, for example, image monitors for personal computers. It is also appreciated that the boards which are connected to the main circuit board 5 and the power supply unit board 6 shown in FIG. 9 but not connected directly to the liquid crystal display panel 4 can be placed inside the casing 10.

1. An image display device comprising:
a casing including a front cabinet and a back cabinet;
a flat display panel placed inside the casing; and
one or more circuit boards with electronic components mounted thereon to cause an image to be displayed on the flat display panel,
wherein a recess is defined on a rear surface of the back cabinet, and at least one of said one or more circuit boards is placed in said recess.

2. The image display device according to claim 1, wherein one or more circuit boards of a plurality of circuit boards to be connected to the flat display panel other than the circuit boards which are attached directly to the flat display panel are placed in said recess.

3. The image display device according to claim 1, wherein all of the circuit boards to be electrically connected directly to the flat display panel other than the circuit boards which are attached directly to the flat display panel are placed in said recess.

4. The image display device according to claim 1, wherein a cover is provided on the rear surface of the back cabinet for covering said recess.

5. The image display device according to claim 1, wherein an opening is defined to penetrate a bottom wall of said recess on the back cabinet, and at least one circuit board in said recess is connected to the flat display panel through the opening.

6. The image display device according to claim 1, wherein the back cabinet is made of synthetic resin and said recess is formed by resin molding.
